(19) United States
(12) Patent Application Publication
(10) Pub. No.: US 2022/0198774 A1
(43) Pub. Date: Jun. 23, 2022

(54) SYSTEM AND METHOD FOR DYNAMICALLY CROPPING A VIDEO TRANSMISSION

(71) Applicant: AI Data Innovation Corporation, Bellevue, WA (US)

(72) Inventors: Ke WANG, Charlottesville, VA (US); Patrick McKinley JARVIS, Redmond, WA (US)

(21) Appl. No.: 17/557,982

(22) Filed: Dec. 21, 2021

Related U.S. Application Data
(60) Provisional application No. 63/129,127, filed on Dec. 22, 2020.

(51) Int. Cl. G06V 10/25; G06T 3/40; G06V 40/20; G06T 7/73

(52) U.S. Cl. CPC G06V 10/25; G06T 3/4053; G06T 3/4007; G06T 2207/20132; G06T 7/73; G06T 2207/20104; G06V 40/20

(57) ABSTRACT

A system and method for dynamically cropping a video transmission includes or cooperates with an image capture device. The image capture device is oriented such that the field of view captures a desired scene from which a region of interest may be automatically determined by a processor utilizing a human pose estimation model including predefined keypoints or key areas. The image capture device may have a common resolution such as 1080p. The processor applies a bounding box over each frame or image corresponding to the region of interest and crops the image to the region of interest. A stabilization algorithm is applied to the cropped image to reduce jitter. The cropped image is rescaled and transmitted to a viewer. A system on the viewer's end may be configured to scale up the rescaled image to a higher resolution using a suitable artificial intelligence modality.

### CROSS-REFERENCE TO RELATED APPLICATIONS

This application claims the benefit of and priority to U.S. Provisional Patent Application No. 63/129,127, filed on Dec. 22, 2020, the entirety of which is incorporated herein by reference.

### TECHNICAL FIELD

The disclosure relates to a system and method for capturing, cropping, and transmitting images, in particular to systems and methods for dynamically and/or automatically processing video, such as a live video transmission.

### BACKGROUND

The sudden and widespread shift to online learning and remote work during the COVID-19 pandemic has exposed the limitations of existing methods and approaches for allowing people to connect, communicate, collaborate, and instruct each other remotely. For example, while video conferencing has allowed people to see each other's faces and hear each other's voices, video conferencing platforms and internet service providers (ISPs) are notoriously limited by the high demands for bandwidth and the associated latency and other data-processing and -transmission issues. Users may experience significant frustration as video and/or audio feeds of a video conference lag, freeze, or drop out entirely.

There is also no way for users to shift the focus of their video transmission other than by manually adjusting the orientation of the camera, often by adjusting the orientation and/or the position of the device in or on which the camera is mounted, such as their laptop computer. As such, most video conferencing is limited to a predefined field of view for each participant.

While video conferencing applications that rely upon a user's webcam may be well-suited to showing the faces and upper bodies of conference participants as they sit at their workstations, they are poorly adapted to transmitting useful video transmissions of more dynamic activities, such as a teacher providing a demonstration of a principle, writing material on one or more whiteboards, or moving about a lecture hall, as the video conferencing application is not able to both automatically follow the activity of the person of interest and crop portions of the video transmission that are not relevant.

Likewise, existing video conferencing solutions are poorly adapted to activities such as telehealth, where a medical professional such as a doctor, nurse, or physical therapist may wish to remotely examine a patient or observe a patient performing an activity of interest, in order to diagnose a problem or assess the patient's progress in recovery. For example, the medical professional may wish to observe the patient's gait to assess recovery from a sports injury, to which task a fixed webcam that focuses on the user's face and upper body is poorly adapted. In other situations, the medical professional may wish to observe a particular region of the patient's body, such as the torso. In existing telehealth applications, the patient must manually position their camera in accordance with the medical professional's spoken directions.

In online lessons, such as music lessons, video conferencing solutions are poorly adapted to switching between showing the teacher and/or student's faces in order to facilitate effective face-to-face communication and focusing the camera on a region of interest, such as the keyboard of a piano or on the student's or the teacher's hands as they play an instrument like the violin. Teachers who have pivoted to online lessons during the COVID-19 pandemic are forced to manually pivot the field of view of the camera of their device, such as their laptop or mobile device, back and forth between the regions of interest throughout the course of the lesson, and they must instruct their students to follow suit as necessary. This is a time-consuming, imprecise, and frustrating experience for all involved.

Existing video conferencing modalities may, because of the static nature of the camera field of view, force a viewer to strain their eyes in order to see, from the captured image, an object or region of interest. For example, a remote university student may have to strain to notice details that a professor writes on one particular section of a whiteboard. Due to low resolution or the field of view being poorly adapted to the region of interest, the viewer may miss altogether important details.

Existing approaches to automatically focusing a camera require expensive and complex actuators that are configured to automatically reposition to focus on an area of interest, such as a lecturer in a lecture hall as they move about the stage or as they write details on the whiteboard. Other existing approaches to capturing a region of interest are focused on providing a super-high-resolution camera from which a detected region of interest may be detected and cropped to reduce the bit-rate for streaming to a remote client and to render the video transmission suitable for display on a standard display screen. Other existing approaches to capturing a region of interest and cropping a video transmission require a receiver, i.e., a viewer, to manually select between predetermined regions of interest throughout a presentation or call. Existing approaches also lack the ability for a presenter, such as a teacher, lecturer, or otherwise, to select and toggle between a desired mode of operation or region of focus.

Because the only way to shift the focus of a video transmission is to provide an expensive and complex actuator system, to provide a super-high-resolution and expensive camera, and/or to require a viewer to select a region of interest, the state of solutions for cropping images or videos to a region of interest are costly, complex, and unwieldy. Existing approaches further require expensive computing resources due to the processing requirements, making a system for dynamically cropping a video transmission prohibitively expensive for most people.

In view of the above-mentioned deficiencies of existing approaches for dynamically cropping a video transmission, there is a need for a system and method for dynamically cropping a video transmission that does not require expensive and complex actuators to move a camera or super-high-resolution cameras. There also is a need for a system and method that reduces bandwidth demands and latency while providing an intuitive and affordable solution for dynamically cropping a video based on a presenter and a receiver's needs.

### SUMMARY

A system and method for dynamically cropping a video transmission according to embodiments of the present disclosure addresses the shortcomings of existing approaches by providing a system that utilizes existing, ordinary cameras, such as webcams or mobile-phone cameras, reduces bandwidth requirements and latency, and provides a presenter with options for toggling between different modes corresponding to a presenter's needs or preferences.

In embodiments, the system and method for dynamically cropping a video transmission includes an image capture device, e.g., a video camera. The camera may be an existing camera of a user's device, such as a laptop computer or a mobile device such as a smartphone or tablet. The camera may have a standard resolution, such as 720p (1280×720), 1080p (1920×1080), 1440p (2560×1440), 1920p (2560×1920), 2k (2560×1440), 4k (3840×2160), 8k (7680×4320) or any other standard resolution now existing or later developed. Accordingly, the embodiments disclosed herein are not limited by the particular resolution, whether a standard resolution or a non-standard resolution, of the camera that is used when implementing the claimed invention. A user may position the camera to capture a desired field of view, which may include an entire room or region comprising a plurality of possible regions of interest.

The system and method may comprise or involve a processor configured to rescale or convert a captured image, such as individual frames of a captured video, to a predetermined size or resolution. The predetermined size or resolution may be, for example, 320×640 or another suitable resolution. The predetermined resolution may be lower than the original resolution of the camera in order to minimize bandwidth requirements and latency. The converted image or frames may be transmitted by a communication module of the system to a communication module of another, cooperating system. The transmitted image or frames may be converted by a processor of the cooperating system to a higher resolution using a suitable modality, such as by use of a deep learning function. The rescaling step may be performed after the determination of a region of interest as discussed below.

The system and method may identify and crop a region of interest using an artificial intelligence model configured for human pose estimation that utilizes keypoint or key area tracking and/or object tracking. In an embodiment, the human pose estimation model may utilize a deep neural net model. The processor may be configured to receive an image or frame of a video and overlay one or more keypoints or key areas and/or bounding boxes to identify the region of interest by including a set of keypoints or key areas of interest. In some embodiments, a bounding shape may be used in place of a bounding box. The system is configured to crop the image or frame based on the identified region of interest in real-time. In some embodiments, before cropping the image the system is configured to perform a distortion correction process and/or a perspective transform process.

The system may be configured to detect and identify predefined keypoints or key areas on each presenter. There may be any suitable number of keypoints or key areas, for instance 17, 25, or any other suitable number. The keypoints or key areas may be predefined to correspond to a desired feature of a person, such as joints including the hip, knee, ankle, wrist, elbow, and/or shoulder, body parts such as the foot tip, hand tip, head top, chin, mouth, eyes, and/or ears, or any other suitable feature.

In embodiments, each keypoint or key area may be connected to a proximate keypoint or key area for purposes of visualization and ease of understanding. For instance, the left foot tip keypoint may be connected by a straight line to the left ankle, which may be connected by a straight line to the left knee, which may be connected by a straight line to the left hip, which may be connected by a straight line to the left shoulder, and so forth. While keypoints or key areas may be connected to each other by an overlaid connecting line, the system and method embodiments may be configured to perform the dynamic cropping operations described herein without overlaying a connecting line. Such connecting lines may be, in embodiments, merely artificial and exterior to the detection of keypoints and key areas, and provision of such connections may advantageously help visualize the detection, for example as a presenter or viewer determines a custom, user-specific mode of operation or as a presenter or viewer reviews the performance of the system.

The system and method may utilize the detected keypoints or key areas to define a bounding box surrounding a region of interest. The bounding box may define the portion of the image or video frame to be cropped, rescaled, and transmitted. In embodiments, the bounding box is defined with a predefined margin surrounding the detected keypoints such that not only does the region of interest capture the parts of the presenter that are of interest but also surrounding context. For example, the predefined margin may allow a viewer to see the keyboard on which a piano teacher is demonstrating a technique without the region of interest being too-narrowly focused on the piano teacher's hands (to the exclusion of the keyboard). Simultaneously, the predefined margin may be narrow enough to allow for sufficient focus on the parts of interest such that the viewer is able to readily see what is happening. In embodiments, the margin may be customized by a user to a particular application.

In embodiments in which key areas are detected, the bounding box may be defined so as to capture an entirety of the key areas of interest. The key areas may include an area, e.g., a circular area, surrounding a likely keypoint with a probability confidence interval, such as one sigma—corresponding to one standard deviation. The key areas may indicate a probability that each pixel in the input image belongs to a particular keypoint. The use of key areas may be advantageous in embodiments as relying on detected key areas allows the system and method to include all or substantially all pixels of a key area in the determination of a region of interest as described herein.

The system and method may further be configured to allow a presenter to select a mode of operation. The modes of operation from which a user may select may be predefined modes of operation, custom-defined modes of operation determined by the user, or a combination. A predefined mode of operation may correspond to a full mode in which all of the identified keypoints or key areas are included in the cropped image and in which no cropping is performed, a body mode in which keypoints or key areas corresponding to the user's body are included and the image is cropped to show an entirety of the presenter's body, a head mode in which keypoints or key areas corresponding to the user's head and/or shoulders are included and the image is cropped to show the presenter's head and optionally neck and shoulders, an upper mode in which keypoints or key areas corresponding to the user's head, shoulders, and/or upper arms are included and the image is cropped to show the presenter's head and upper torso, for example to approximately the navel, a hand mode in which keypoints or key areas corresponding to the user's hands, wrists, and/or arms are included and the image is cropped to show one or more of the presenter's hands and optionally arms, a leg mode in which keypoints or key areas corresponding to the user's feet, legs, and/or hips are included and the image is cropped to show one or more of the presenter's legs, or any other suitable mode.

One or more of the above-described modes or other modes may be predefined in the system and ready for use by a user. The user may also or alternatively define one or more custom, user-specific modes of operation, for example by selecting the keypoints or key areas that the user wishes to be included in the mode and other parameters such as margins for four directions. For example, in certain embodiments the system and method may be configured to provide a mode in which the image is cropped to show the presenter's head and hands, such as when a piano teacher is instructing a student on how to perform a certain technique. A violin teacher may use a mode in which the image is cropped to show the presenter's head, left arm, the violin, and the bow. A lecturer may select a mode in which the image is cropped to show the lecturer and a particular section of a whiteboard or a demonstration that is shown on a table or desk, such as a demonstration of a chemical reaction or a physics experiment.

The user may define in a custom, user-specific mode of operation one or more keypoints or key areas to include in the region of interest and/or an object to detect and include. For example, a music teacher may specify that a demonstration mode of operation includes not only the teacher's hands and/or head but also the instrument being used in the demonstration. A physical therapist using the system and method in a telehealth application may specify that a particular mode of operation tracks a user performing certain exercises with free weights which are tracked by the system. A lecturer may specify a lecture mode of operation that includes object detection of a pointer used by the lecturer. The system may be configured to cooperate with one or more suitable object detection models that may be selected based on the user's custom, user-specific mode of operation, such as to detect an instrument, a medical-related object, a lecture-related object, or otherwise.

The system may define a user interface on an input device, display, or otherwise in which the user may be guided to create a user-specific mode of operation, such as by selecting the keypoints or key areas of interest to include in a particular mode, such as the keypoints or key areas corresponding to a particular medical observation, technical demonstration, or other presentation, and/or a model for detecting objects of interest. In embodiments, the user may utilize a combination of one or more predefined modes of operation and one or more custom, user-specific modes of operation.

In an embodiment, the presenter may be a lecturer presenting information on one or more whiteboards. The system and method may be configured to identify one or more labels, such as a barcode, Aruco codes, QR codes, or other suitable markers or codes on one or more of the whiteboards that may correspond to a mode of operation among which the system may automatically toggle, or the presenter or viewer may manually toggle. The presenter thus may direct viewers' attention to a whiteboard of interest by toggling to the corresponding mode of operation. In embodiments, the system is configured to extend the detection of keypoints and key areas beyond a human and to desired labels, general objects, and/or specific objects. The detection of keypoints or key areas may include a combination of one or more human keypoints or key areas, as discussed above, and one or more objects, such as a label, a general object, or a specific object.

A general object may include a class of objects, such as a whiteboard generally, a tabletop generally, an instrument (such as a piano or a violin) generally, or any other object. In embodiments, the system is configured to extend keypoint or key area detection to a plurality of objects. The system may be configured to allow a presenter or viewer to use a pretrained model or to train the system to recognize a general class of objects. This may be done, in embodiments, by “showing” the system the general object in one or more angles, by holding and manipulating the object within the field of view of one or more cameras of the system and/or in one or more different locations. The system may also utilize one or more images uploaded of the general object class and/or may cooperate with a suitable object detection model that may be uploaded to the system.

A specific object may include any suitable object that is specific to a presenter or viewer. For example, a teacher may wish for the system to detect a particular textbook or coursebook but not books generally. The system may be configured to be trained by a presenter or viewer to recognize one or more specific objects, for example by prompting the presenter or viewer through a user interface to hold and/or rotate the object within a field of view of one or more cameras so that the system may learn to recognize the specific object.

A specific object may include an instrument, such as a violin and/or corresponding bow. The presenter and/or viewer may specify a mode of operation in which the system recognizes and automatically includes the violin in a cropped image by placing and/or manipulating the violin within a field of view of the camera. In embodiments, one or more keypoints or key areas on the object may be specified. The presenter or viewer may apply markings onto areas of the surface of the object before placing the object in the field of view of the camera so as to train the system to identify the markings as keypoints or key areas. In other embodiments, the presenter or viewer may annotate one or more frames of a captured video or image to denote the keypoints or key areas of the object and/or bounding boxes corresponding to the keypoints or key areas and the object of interest. This allows the system to extract features of interest for accurate and automatic detection of the object when pertinent.

In embodiments, a presenter may train the system to recognize a plurality of specific items, such as coursebooks or other materials for a student or class as opposed to books generally. The system may then automatically extend detection to the specific items when the items appear within the field of view of the image capture device such that the region of interest captures an entirety or portion of the specific items. In embodiments, the presenter may determine one or more custom, user-specific modes of operation between which the presenter may toggle, such as to specify a mode in which one or more objects are automatically detected by extending keypoint or key area detection to the one or more objects and included in the cropped image and/or a mode in which the one or more objects are not included in the cropped image, i.e., ignored.

The system may likewise be configured to recognize a one or more labels (such as a barcodes, a QR codes, an Aruco codes, plain text, or any other suitable label) by uploading the one or more labels through a user interface or by arranging the field of view to capture the label (such a label placed on or adhered to a whiteboard or other object surface) such that the system may be configured to recognize such labels. In embodiments, the system is configured to extend keypoint or key area detection beyond one or more presenters and to include one or a combination of labels, objects, and a general objects.

By providing a system that is configured to extend a keypoint or key area detection analysis to one or more keypoints or key areas of one or more of a specific object, a general object, and a label, the system advantageously allows presenters and viewers to effectively utilize the system in an unlimited number of contexts. The presenters and viewers may perform numerous presentations, lectures, lessons, and otherwise using the system with automatic, dynamic, and accurate detection of regions of interest.

While the above plurality of modes of operation has been described, it will be appreciated that in embodiments, a system and method may include a single mode of operation. For example, the system may comprise a suitable artificial intelligence model trained specifically to the mode of operation, such as an upper mode focused on the head and shoulders of a presenter, a hands mode focused on the hands, wrists, and arms of a presenter, or otherwise.

The presenter may select the mode of operation in any suitable manner, including by performing a gesture that the system is configured to recognize, by speaking a command, by actuating a button on a remote control, by selecting a particular region on a touchscreen showing the current video transmission, or by pressing a button on an input device for the system, such as a keyboard or touchscreen.

In embodiments, the viewer may also toggle between different modes of operation, independently of the presenter or in conjunction with the presenter. For example, the viewer may wish to zoom in on a particular section of a whiteboard on which the presenter has written a concept of interest. The system and method may be configured to allow the user to view a selected region of interest as picture-in-picture with the presenter's chosen mode of operation, in lieu of the presenter's chosen mode of operation, side-by-side with the presenter's chosen mode of operation, or otherwise.

The system and method may also or alternatively provide an automatic cropping feature, in which the system automatically determines a region of interest based on, for example, an area of greatest activity. For example, a presenter may demonstrate a piano technique using their hands, and based on the detected activity of the hands and the associated keypoints or key areas, the processor may determine that the region of interest surrounds the hands. The video transmission then can be dynamically cropped to remove regions of the video transmission outside of the region of interest. The processor may automatically toggle between predetermined modes of operation, such as a full mode, body mode, head mode, upper mode, hand mode, leg mode, or otherwise.

It will be appreciated that in some instances there may be more than one presenter. For example, there may be two presenters who are playing a duet on the piano at the same time. In such instances, the system and method may also or alternatively provide the automatic cropping feature, in which the system automatically determines a region of interest based on both sets of hands of the two presenters playing the duet. The video transmission then can be dynamically cropped to remove regions of the video transmission outside of the region of interest. The processor may automatically toggle between predetermined modes of operation, such as a full mode, body mode, head mode, upper mode, hand mode, leg mode, or otherwise. Accordingly, the embodiments disclosed herein are applicable to any number of presenters as circumstances warrant.

It will also be appreciated that role of “presenter” and “viewer” or “receiver” in the embodiments disclosed herein are able to dynamically change. For example, in an embodiment a piano teacher may initially be presenter as the system determines the region of interest that is focused on the teacher playing the piano keys so that this can be viewed by a student as a viewer or receiver. Later, the student may become the presenter as the system determines the region of interest that is focused on the student playing the piano keys in the manner shown by the teacher so that this can be viewed by the teacher as the viewer or receiver.

In embodiments, the system may automatically determine the region of interest based on the keypoints or key areas that are estimated to be closest to the camera. For instance, the system may determine from a captured image that the presenter's face is closest to the camera based on the proximity of the face keypoints or key areas (eyes, ears, nose, mouth, etc.) to the camera. In embodiments, the system may utilize images from two or more cameras to determine 3D features and information, such as depth, to determine a region of interest based on proximity to one or more of the cameras.

The system may automatically determine a region of interest in any other suitable manner. For example, the system may determine a region of interest based on one or more of the keypoints or key areas that move the most from frame to frame or based on one or more of the detected keypoints or key areas defining a particular pattern of movement, for example a repetitive pattern or an unusual pattern.

The system may be configured to automatically scale up the resolution of the transmitted cropped image on the viewer's end. The system may comprise or cooperate with a neural network or other artificial intelligence modality to upscale the transmitted cropped image, for example back to the predetermined display resolution, such as 720p or 1080p or other suitable display resolutions. The neural network may be configured to upscale the transmitted cropped image by a predetermined factor, such as a factor of 2, 3, 4, or any other suitable factor.

The system may comprise or be deployed and/or implemented partially or wholly on a hardware accelerator that is configured to cooperate with the presenter's computer. The hardware accelerator may define or comprise a dongle or attachment comprising for example a processor and a storage device, such as but not limited to a Tensor Processing Unit (TPU), such as the Coral TPU Accelerator available from Google, LLC of Mountain View, Calif. and may be configured to perform a portion or an entirety of the image processing. In embodiments, the hardware accelerator may be a Graphics Processing Unit (GPU), a Field Programmable Gate Array (FPGA), or otherwise. The hardware accelerator may be any device configured to supplementing or replacing the processing abilities of an existing computing device.

By providing the hardware accelerator, the system may be performed using a presenter's existing computer or mobile device without requiring the user to purchase a device with a particularly powerful processor or a specialized camera, making the system not only more effective and intuitive but also more affordable for more presenters than existing solutions. The hardware accelerator may cooperate with or connect to a computer or mobile device through any suitable modality, such as by a Universal Serial Bus (USB) connection. The use of the hardware accelerator may also reduce latency and facilitate image processing prior to transmission, resulting in a more fluid video stream. In embodiments, a user's computer or mobile device has sufficient processing capability to operate the system and method embodiment and does not use a hardware accelerator.

### BRIEF DESCRIPTION OF THE DRAWINGS

These and other features, aspects, and advantages of the present disclosure will become better understood regarding the following description, appended claims, and accompanying drawings.

FIG. 1A is a flowchart of a system and method for dynamically cropping a video transmission according to an embodiment of the present disclosure.

FIG. 1B is a flowchart of the system and method for dynamically cropping a video transmission according to the embodiment of FIG. 1A.

FIG. 2 is a diagram of the system and method for dynamically cropping a video transmission according to the embodiment of FIG. 1A.

FIG. 3A shows a method for dynamically cropping a video transmission according to an embodiment.

FIG. 3B shows a method according to the embodiment of FIG. 3A.

FIG. 4A is a diagram of a system for dynamically cropping a video transmission according to an embodiment.

FIG. 4B is a diagram of a system for dynamically cropping a video transmission according to another embodiment.

FIG. 5 is an annotated image generated by a system for dynamically cropping a video transmission according to an embodiment of a mode of operation.

FIG. 6 is an annotated image generated by a system for dynamically cropping a video transmission according to an embodiment of another mode of operation.

FIG. 7 is an annotated image generated by a system for dynamically cropping a video transmission according to an embodiment of another mode of operation.

FIG. 8 is an annotated image generated by a system for dynamically cropping a video transmission according to an embodiment of another mode of operation.

FIG. 9 is an annotated image generated by a system for dynamically cropping a video transmission according to an embodiment of another mode of operation.

FIG. 10 is an annotated image generated by a system for dynamically cropping a video transmission according to an embodiment of another mode of operation.

### DETAILED DESCRIPTION OF VARIOUS EMBODIMENTS

### A. Overview

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. It should be understood, however, there is no intention to limit the disclosure to the specific embodiments disclosed, but on the contrary, the intention covers all modifications, alternative constructions, combinations, and equivalents falling within the spirit and scope of the disclosure.

It will be understood that unless a term is expressly defined in this application to possess a described meaning, there is no intent to limit the meaning of such term, either expressly or indirectly, beyond its plain or ordinary meaning.

### B. Various Embodiments and Components for Use Therewith

Embodiments of a system and method for dynamically cropping a video transmission are shown and described. The system and method may advantageously address the drawbacks and limitations of existing approaches to video conferencing and remote learning by providing a system that dynamically crops a video transmission to a detected region of interest without the need for a user, such as a presenter or viewer, to purchase a high-cost camera or computer.

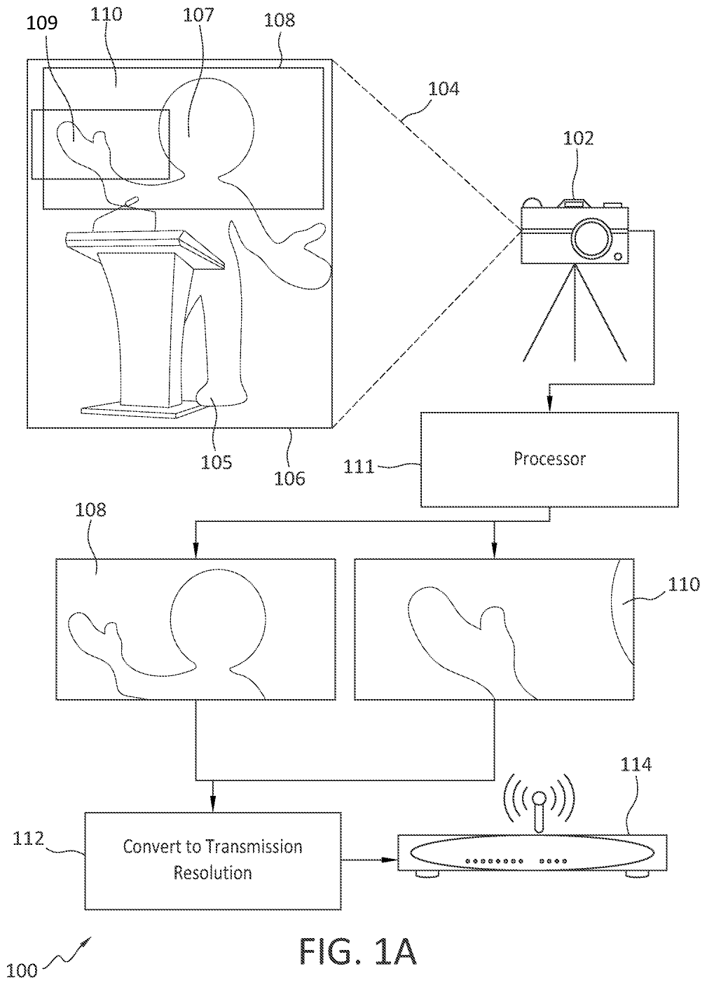

Turning to FIG. 1A, a system and method for dynamically cropping a video transmission according to an embodiment is shown. The system 100 may include or be configured to cooperate with one or more image capture devices 102. The image capture device 102 may be any suitable image capture device, such as a digital camera. The image capture device 102 may be an integrated camera of a smartphone, a laptop computer, or other device featuring an integrated image capture device. In embodiments, the image capture device 102 may be provided separate from a smartphone or laptop computer and connected thereto by any suitable manner, such as a wired or wireless connection. The image capture device 102 may be configured to capture discrete images or may be configured to capture video comprising a plurality of frames.

In embodiments, the image capture device 102 has a resolution that is standard in most smartphones and laptop cameras, such as 720p or 1080p, referred to herein as a capture resolution. It will be understood that the image capture device 102 is not limited to 720p or 1080p, but may have any suitable resolution and aspect ratio.

The image capture device 102 may have a field of view 104 that a presenter or other user may select by adjusting a position of the camera. In embodiments where a laptop computer is used, the laptop may be positioned such that the field of view 104 of the camera 102 is directed in a desired orientation. The presenter may adjust the laptop until the field of view 104 captures a desired scene. For example, the field of view 104 may capture an entirety or a substantial entirety of a region where any activity of interest may take place such that a region of interest selected from the field of view 104 may be selectively cropped from the video transmission and transmitted to a viewer.

In a lecture setting, the field of view 104 may be oriented to capture the lectern, the whiteboards, and any space in which the lecturer prefers to stand when lecturing. In a music-lesson setting, the field of view 104 may be oriented so as to capture an entirety of an instrument such as a violin or the pertinent parts of an instrument like a piano, such as the keyboard, the piano bench, and the space where a teacher may sit and demonstrate techniques. In a medical setting, the field of view 104 may be oriented to capture an area where a patient remotely consulting with their physician or other medical professional can demonstrate a condition or action. For example, the field of view 104 may be oriented to show the patient performing an exercise of a physical-therapy regimen for a physical therapist's supervision and/or observation.

With the image capture device 102 and the field of view 104 positioned as desired, the system 100 may be configured to capture an image 106. The image 106 may be a single, discrete image, or a frame of a video transmission comprising a plurality of frames. The image 106 may capture a presenter 105 or object of interest performing one or more functions. For example, the presenter 105 may be speaking or demonstrating. The image 106 may include the presenter's head 107 and/or the presenter's hand 109, from which the system 100 may determine a region of interest as described in greater detail herein.

The captured image 106 may be transmitted to a processor 111 by any suitable modality for determining the region of interest and dynamically cropping the captured image 106. The processor 111 may be a processor (e.g., processor 405 and/or 455) of a device, such as a laptop computer, with which the image capture device 102 is integrated. Alternatively, or in addition, the processor 111 may be provided separately from a device such as a laptop with which the image capture device 102 is integrated. For instance, the processor 111 may be provided on a hardware accelerator or dongle (e.g., processor 408 of accelerator 401) that the presenter may connect to the device with which the image capture device 102 is integrated. This advantageously reduces the cost of the system 100, as a presenter wishing to use the system and method of the present disclosure need not purchase a laptop or other device with a particularly powerful processor in order to operate the system or method, but rather may use their existing laptop or other device. The use of a hardware accelerator is not always necessary, and a user may rely upon the integrated processing power of any suitable device.

The processor 111 may utilize a suitable artificial intelligence modality (e.g., artificial intelligence modules 425, 435, and/or 475) to determine the region of interest and dynamically crop the video transmission to show only the region of interest. Although shown as being separate from the processors 111, 405, 408, and 455, this is for ease of illustration as in embodiments the artificial intelligence modules 425, 435, and/or 475 are instantiated in or included in the processors 111, 405, 408, and 455. In an embodiment, the processor 111 may cooperate with a machine learning algorithm or model instantiated or included in the artificial intelligence modules 425, 435, and/or 475 and configured for human pose estimation, such as but not limited to a deep neural net model, which utilizes keypoint or key area tracking and/or object tracking. The processor 111 may apply or overlay one or more keypoints or key areas to the image 106 of the presenter 105, the keypoints or key areas corresponding to features of the presenter. The system 100 may be configured to detect and identify one or more predefined keypoints or key areas on each presenter 105.

There may be any suitable number of keypoints or key areas, for instance 17, 25, or any other suitable number. The keypoints or key areas may be predefined to correspond to a desired feature of a person, such as joints including the hip, knee, ankle, wrist, elbow, and/or shoulder, body parts such as the foot tip, hand tip, head top, chin, nose, mouth, eyes, and/or ears, or any other suitable feature. Any suitable combination of keypoints or key areas may be utilized.

Each of the keypoints or key area may be connected to or associated with predicted or estimated keypoints or key areas predicted by the machine learning algorithm. For instance, the system may be configured to show the left foot tip keypoints or key areas as being connected by a straight line to the left ankle, which may be connected by a straight line to the left knee, which may be connected by a straight line to the left hip, which may be connected by a straight line to the left shoulder, and so forth. Keypoints or key areas may also connect laterally to an adjacent keypoint or key area; for example, the left hip keypoints may be connected by a straight line to the right hip keypoints, the left shoulder keypoints may be connected by a straight line to the right shoulder keypoints, the left eye keypoints may be connected to the right eye keypoints, and/or any other suitable connection between keypoints. The connections between keypoints or key areas may be omitted in embodiments, with the determination of the region of interest conducted on the basis of the keypoints or key areas without consideration of or overlaying a connecting line between keypoints or key areas. Such connections and connecting lines may be, in embodiments, merely artificial and external to the detection of keypoints and key areas, and provision of such connections may advantageously help visualize the detection, for example as a presenter or viewer determines a custom, user-specific mode of operation or as a presenter or viewer reviews the performance of the system.

The system 100 may utilize the detected keypoints or key areas to infer and define a bounding box surrounding of the detected keypoints and key areas of interest. The bounding box may comprise at least two corner points and define the portion of the image or video frame to be cropped, rescaled, and transmitted. While keypoints have been described, it will be understood that the system 100 may make use of any suitable modality, including the detection of one or more key areas, and detection approaches including regression-based and heatmap-based frameworks, to identify a region of interest within the image 106.

The system 100 may utilize a direct regression-based framework to identify and apply the one or more keypoints or key areas, a heatmap-based framework, a top-down approach, a bottom-up approach, a combination thereof, or any other suitable approach for identifying the keypoints or key areas. A direct regression-based framework may involve the use of a cascaded deep neural network (DNN) regressor, a self-correcting model, compositional pose regression, a combination thereof, or any other suitable model. A heatmap-based framework may involve the use of a deep convolutional neural network (DCNN), conditional generative adversarial networks (GAN), convolutional pose machines, a stacked hourglass network structure, a combination thereof, or any other suitable approach. In embodiments, direct regression-based and/or heatmap-based frameworks may make use of intermediate supervision.

In embodiments, a heatmap-based approach outputs a probability distribution about each keypoint or key area using a DNN from which one or more heatmaps indicating a location confidence of a keypoint or key area are detected. The location confidence pertains to the confidence that the joint or other feature is at each pixel. The DNN may run an image through multiple resolution banks in parallel to capture features at a plurality of scales. In other embodiments, a key area may be detected, the key area corresponding generally to an area such as the elbow, knee, ankle, etc.

A top-down approach may utilize a suitable deep-learning based approach including a face-based body detection for human detection, denoted for example by a bounding box from or in which keypoints or key areas are detected using a multi-stage cascade DNN-based joint coordinate regressor, for example. A “top-down approach,” as defined herein, indicates generally a method of identifying humans first and then detecting keypoints or key areas of the detected humans.

A bottom-up approach may utilize a suitable keypoint or key area detection of body parts in an image or frame, which may make use of heatmaps, part affinity fields (PAFs), or otherwise. After identifying keypoints or key areas, the keypoints or key areas are grouped together, and persons are identified based on the groupings of keypoints or key areas. A “bottom-up approach,” as defined herein, indicates generally a method of identifying keypoints or key areas first and then detecting humans from the keypoints or key areas.

The system 100 may utilize two categories of keypoints or key areas with separate models utilized by the processor 111 for each category. A first category of keypoints or key areas may include keypoints or key areas automatically generated by a suitable model as described above, such as a machine learning model. In embodiments, the first category of keypoints or key areas are semantic keypoints identified by a first model, such as a deep learning method, for example Mask RCNN, PifPaf, or any other suitable model. The keypoints or key areas automatically generated for the first category may include a nose keypoints or key areas, a left eye keypoints or key areas, a right eye keypoints or key areas, a left ear keypoints or key areas, a right ear keypoints or key areas, a left shoulder keypoints or key areas, a right shoulder keypoints or key areas, a left elbow keypoints or key areas, a right elbow keypoints or key areas, a left wrist keypoints or key areas, a right wrist keypoints or key areas, a left hip keypoints or key areas, a right hip keypoints or key areas, a left knee keypoints or key areas, a right knee keypoints or key areas, a left ankle keypoints or key areas, a right ankle keypoints or key areas, combinations thereof, or any other suitable keypoint or key area.

A second category of keypoints or key areas may include estimated or predicted keypoints or key areas obtained or derived from the first category of keypoints or key areas using geometric prediction, such as a head top keypoints or key areas, a right handtip keypoints or key areas, a left handtip keypoints or key areas, a chin keypoints or key areas, a left foot keypoints or key areas, a right foot keypoints or key areas, combinations thereof, or other keypoints or key areas, optionally using a second suitable model and based on the first category of automatically generated keypoints or key areas. In embodiments, the second category of keypoints may be interest points, and may be determined by a same model as the first category or a distinct, second model, which may include one or more machine learning model such as Moco, SimCLR, or any other suitable model. The second model may be configured to predict or estimate the second category of keypoints as a function of and/or subsequent to detection of the first category of keypoints.

The processor 111 of the system 100 may determine that a region of interest 108 includes the presenter's head 107 and hand 109, with a cropped image output by the processor 111 including only the region of interest 108, with the remaining areas of the image 106 automatically cropped out. Alternatively, the processor 111 may determine that a region of interest 110 includes the presenter's hand 109 only, with a cropped image output by the processor 111 automatically removing the remainder of the image 106. At a step 112, the system 100 may convert the cropped image 108, 110 to a standard size, e.g., a transmission resolution, for transmitting the image 108, 110. The step 112 may utilize the processor 111. The cropped image 108, 110 may retain a same aspect ratio before and after cropping and rescaling.

The processor 111 may utilize an appropriate stabilization algorithm to prevent or minimize jitter, i.e., the region of interest 108, 110 jumping erratically. It has been surprisingly found that by providing a stabilization algorithm, the region of interest 108, 110 not only provides a tolerable viewing experience for a user, as the image does not shake or change based on small, insignificant movements by the presenter, it also prevents misdetection. The use of the stabilization algorithm further addresses jitter due to insignificant detection noise. For example, from frame to frame the detected keypoints or key areas may draft or float by a degree due to noise or key point or key area prediction or estimation errors based on minute changes based on the detected distribution of possible keypoint locations, which may result in the region of interest and the cropped image shifting from frame to frame by minute amounts, which may be frustrating and visually challenging to a viewer. The use of the stabilization algorithm described in combination with the use of keypoint or key area detection as described herein advantageously allows for the real-time detection and cropping of a region of interest based on real-time, dynamic movements by a presenter, such as a lecturer or teacher, while rendering the transmitted, cropped video to a viewer in a stabilized manner, with reduced jitter, that is tolerable to view, and with reduced tendency for the determined region of interest to shift because of insignificant movements by the lecturer.

For example, as a piano teacher demonstrates a technique to a student, the stabilization algorithm prevents the system 100 from determining that the region of interest 108, 110 has moved to a degree to the left or right, and/or up or down, based on the movement of the teacher's arms to a relatively small degree relative to the keyboard. The stabilization algorithm ensures that the region of interest 108, 110 remains centered on the piano teacher and the keyboard or on the piano teacher's hands and the keyboard, as the case may be, without visible perturbations from the teacher's hands moving slightly back-and-forth throughout the demonstration.

In another embodiment, as a lecturer speaks behind a lectern, the stabilization algorithm advantageously smooths the region of interest across one or more frames to counteract the movement of the region of interest automatically detected by the system 100 on the basis of, for example, facial expressions of the lecturer and/or slight, insignificant movement of the head as the lecturer speaks. The stabilization algorithm used in combination with the keypoint or key area detection model thus reduces jitter and instances where the region of interest is mistakenly detected as having moved without reducing the ability of the system 100 to accurately track a region of interest based on, for example, motion by a presenter's head, hands, arms, or otherwise.

In embodiments, the stabilization algorithm may be a stabilization algorithm suitable for use with, for example, a hand-held camera. The algorithm may proceed by computing the optical flow between successive frames, followed by estimating the camera motion and temporally smoothing the motion vibrations using a regularization method. In other embodiments, the stabilization algorithm may be a stabilization algorithm suitable for use with digital video and proceeds with feature extraction, motion estimation, motion smoothing, and image composition steps, in which in the motion estimation step transformation parameters between frames are derived, in the motion smoothing step unwanted motion is filtered out, and in the image composition step the stabilized video is reconstructed. The determination of transformation parameters may include tracking feature points between consecutive frames.

In embodiments, the stabilization algorithm is applied to the captured images by the processor 111 before the captured images are transmitted to a viewer. In other embodiments, the stabilization is algorithm is applied to transmitted images by the processor 158. In certain embodiments, a stabilization algorithm may be applied by the processor 111 prior to transmitting an image, and a second, distinct stabilization algorithm may be applied by the processor 158 to a transmitted image. For example, a presenter who transmits a region of interest to a plurality of viewers may preferably have the processor 111 apply the stabilization algorithm. A presenter transmitting to a single viewer may have the processor 158 apply the stabilization algorithm.

The standard size to which the system 100 may convert the cropped image 108, 110 may be a reduced resolution (referred to herein as a “transmission resolution”) compared to the resolution of the original image 106 (referred to herein as a “capture resolution”) to facilitate transmission without causing bandwidth issues. For example, whereas the image 106 may have a capture resolution of, for example, 760p or 1080p, prior to transmission, the standard size or transmission resolution may be a reduced resolution of 640×320 or any other suitable resolution. While the cropped image 108, 110 has been described, it will be appreciated that in embodiments, no cropping is performed, and the full image 106 is rescaled to the transmission resolution before transmitting. By reducing the resolution of the image 106, 108, 110 prior to transmitting, network bottlenecks are avoided or mitigated, and latency on both the presenter's end and the viewer's end is reduced.

The converted image 108, 110 may be transmitted through a communication module 114 to a receiver, such as a viewer. The communication module 114 may be any suitable modality, including a wired connection or a wireless connection such as Wi-Fi, Bluetooth, cellular service, or otherwise. Turning to FIG. 1B, a system 150 allows a receiver, such as a viewer, to receive through a communication module 156 the cropped, converted images 108, 110 from the presenter. The communication module 156 may likewise be any suitable modality facilitating wired or wireless connection to the system 100.

The system 150 may comprise a processor 158 configured to scale up the cropped, converted images 108, 110 to a suitable resolution, for example 720p or 1080p, referred to herein as the “display resolution.” In embodiments, the processor 158 may be configured to scale up the images 108, 110 to the display resolution, which may be a user-defined resolution or automatically adapted to the display device, such as a monitor, a projector, an augmented reality (AR) device, a virtual reality (VR) device, or a mixed reality (MR) device in the viewer side of the image 106 as captured by the image capture device 102 of the system 100. In other embodiments, the processor 158 is configured to scale up the images 108, 110 to a display resolution independent of the capture resolution. For example, the display resolution may be determined by the processor 158 and/or a display 160 of the system 150. The display resolution may likewise be determined as a preference of the receiver.

The processor 158 may utilize any suitable modality to display the resolution of the images 108, 110. In an embodiment, the processor 158 comprises or is configured to cooperate with an artificial intelligence module, such as a deep learning-based super-resolution model, which is the process of recovering high-resolution (HR) images from low-resolution images, a neural network-based model, or any other suitable modality. The artificial intelligence module may be configured to automatically accommodate the resolution of the display 160 of the system 150 as it scales up the images 108, 110.

The scaled-up images 108, 110 may then be shown on the display 160 for the viewer in the display resolution—a user-defined resolution or automatically adapted to the display device, such as a monitor or a projector, in the viewer side, with the image 106 having been automatically and dynamically cropped in real-time or substantial real-time while minimizing network or bandwidth bottlenecks due to the volume of data transmitted. The scaled-up images 108, 110 may have a same aspect ratio as the original image 106 and, to the extent necessary, may be displayed with one or more margins 161 or as cropped such that the aspect ratio of the original image 106 and the aspect ratio of the display 160 may be resolved. While an aspect ratio corresponding to 1080p is contemplated, it will be appreciated that any suitable resolution and any suitable aspect ratio may be utilized.

As mentioned, the scaled-up images 108,110 may include or be displayed with one or more margins 161. The margin 161 is configured to allow a presenter or viewer or other user to define a space in four directions that surrounds the bounding box. In embodiments, the four directions of the margin 161 may include a top margin, a bottom margin, a left side margin, and a right side margin, each of which may be configurable as needed, either automatically by the system or manually by the presenter or viewer or other user. In embodiments the presenter or viewer or other user can select an absolute number of pixels for each margin or alternatively can select a percentage of pixels in the corresponding direction for each margin.

For instance, suppose that the tight bounding boxes for the image 108,110 were 100 pixels in width, where the tight bounding boxes are the smallest bounding boxes including the keypoints or key areas of interest without margins. The presenter, viewer or other user could select each margin of left and right to be 10 pixels so that the final bounding boxes with margins have 120 pixels in width. Alternatively, given that images 108 and 110 have the tight bounding boxes 60 in height, the presenter, viewer or other user could select the top and bottom margins to be 5 pixels so that the final bounding boxes with margins have 70 pixels in height. Of course, the presenter, viewer or other user could select a different number of pixels for the margin of each direction.

Alternatively, the presenter, viewer or other user could select each margin to be a percentage of the image pixels. Thus, if the tight bounding boxes of image 108,110 were 100 pixels in width and 60 pixels in height, then the presenter, viewer or other user could select each margin portion be 15% (15 pixels) so that the final bounding boxes with margins have 130 pixels in width. Alternatively, the presenter, viewer or other user could select the top and bottom margin portions to be 5% (5 pixels) so that the final bounding boxes with margins have 70 pixels in height. Of course, the presenter, viewer or other user could select a different percentage of image pixels for the margin in each direction. In other embodiments, the system may suggest a number of pixels or a percentage of pixels that may be used in each margin. This allows the presenter, viewer or other user to have control over how the image is later cropped and displayed on the display 160.

The procedure shown in FIGS. 1A and 1B is accomplished without the presenter or the viewer having to manually adjust the image capture device 102 and its field of view 104, providing a complex and expensive actuator to adjust the field of view of the image capture device or a plurality of image capture devices each positioned to capture an individual region of interest, or requiring the purchase and use of an expensive computer and/or camera having high processing power and super-high resolution.

In embodiments, multiple image capture devices may be utilized by the system and method. For instance, many smartphones have multiple cameras configured to cooperate for capturing an image or frames of a video. Additionally, standalone cameras may be easily added to or used in cooperation with devices on which the system and method may be performed, such as a laptop computer. In embodiments, a lecturer may make use of a camera installed in a lecture hall and of an embedded webcam in a laptop computer or a camera of a smartphone. The lecture-hall camera may be used for capturing the lecturer speaking behind a lectern and writing on a whiteboard, while a camera of a laptop or smartphone may be positioned so as to allow for a different angle of view or perspective on, for example, a demonstration, such as a chemistry or physics experiment.

The system may be configured to toggle between modes of operation and/or between camera sources such that images from a single camera are captured, processed, and transmitted when appropriate. For example, a presenter may specify a custom demonstration mode that utilizes the demonstration camera and/or a particular mode of operation, such as one configured to recognize a particular object the system is trained to recognize.

In other embodiments, a piano teacher may position a camera above a keyboard and looking down thereon and another camera facing the piano bench from a side angle, such that the system may toggle automatically or at the presenter's direction from the above-keyboard camera to the side camera based on the progress of the lesson, for example when the piano teacher is speaking to the side camera to explain a technique or theory to a student learning remotely. The teacher may specify a mode of operation corresponding to the side camera and/or to the above-keyboard camera as desired. A presenter may manually toggle between modes of operation corresponding to a specific camera in any suitable manner.

The system may be configured to automatically switch between multiple cameras of a multi-camera embodiment based on any suitable indicator. For example, the system may switch away from a camera when a predefined number of human keypoints or key areas cannot be detected in images captured from the camera, for example when a presenter steps out of the field of view of the camera. The predefined number of keypoints or key areas may be any suitable number, such as one, five, 10, 17, or any other suitable number. In other embodiments, the system may be configured to automatically switch to utilizing the images captured from a camera within the field of view of which a greater number of keypoints or key areas are visible and detectable, for example because of less occlusion. In other embodiments, the system may be configured to automatically switch between cameras based on a size of a bounding box inferred from detected keypoints, i.e., such that the camera in which the presenter is most easily visible e.g., due to proximity to the camera is selected. The system may be configured to switch between cameras based on the orientation of the cameras, for example such that the camera oriented so as to best serve a particular mode of operation, such as a LEG mode of operation due to the camera being oriented downwardly, is automatically selected.

While the above-described methods for switching between multiple cameras have been described, it will be appreciated that the system may utilize any suitable modality for switching between cameras. In embodiments, the system may utilize a combination of a presenter manually switching between modes of operation, such as user-specific modes of operation corresponding to specific cameras, and the system automatically switching between cameras as suitable based on a detected number of keypoints or key areas or otherwise.

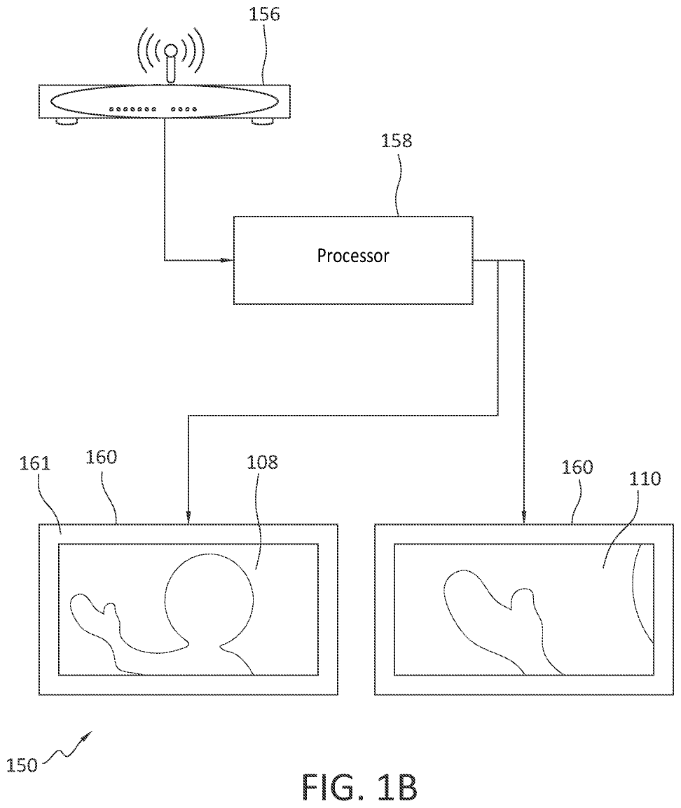

Turning to FIG. 2, a diagram 200 of an image 206 of a presenter 205 is shown. The image 206 may be captured by one or more suitable image capture devices as described regarding the embodiment of FIGS. 1A and 1B, and may have a standard, common resolution such as 1080p. The image 206 may have a height 210 of 1080 pixels and a width of 1920 pixels. Using resolutions such as 1080p allows a system and method according to embodiments of the present disclosure to utilize existing webcams of laptops and cameras in standard smartphones, such that a presenter need not purchase a super-high resolution image capture device. The resolution may be large enough to allow for the identification of a discrete region of interest 208 within the image 206. Within the image 206, multiple instances 214 of a smaller, standard resolution such as 320×640 may fit, allowing the system to select numerous possible regions of interest within the image 206 that may be transmitted to a viewer.

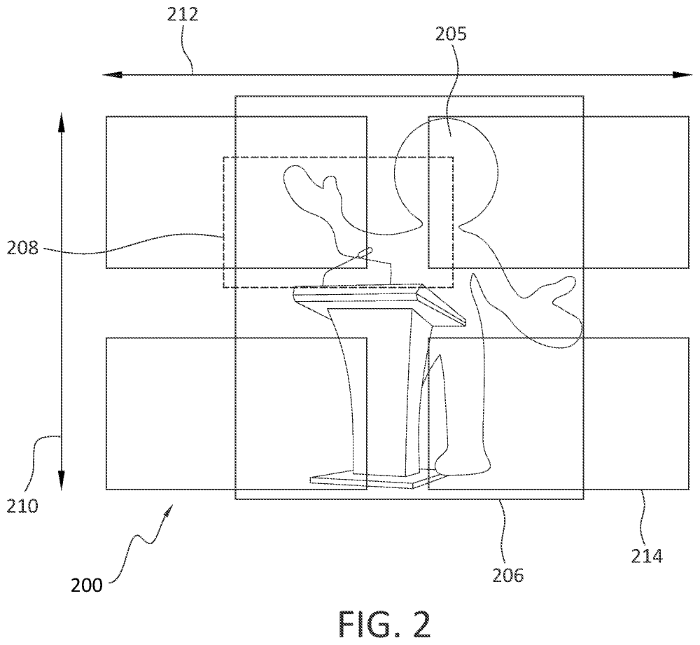

A method 300 for dynamically cropping a video transmission according to an embodiment of the present disclosure is shown and described regarding FIG. 3A. The method 300 may include the following steps, not necessarily in the described order, with additional or fewer steps contemplated by the present disclosure. At a first step 302, a camera may be positioned to capture a field of view.

The camera may be initially positioned by a presenter such that the field of view captures all possible regions of interest during the presentation such that the presenter need not manually adjust the camera during the presentation but rather may rely on the system to automatically and dynamically crop the video transmission to show only the region of interest at any given time. The camera may have a resolution standard in existing laptops and smartphones, for example 1080p. The camera may be integrated with a device such as a laptop or smartphone, or may be provided independently thereof.

At a second step 304, at least one image or video frame of the field of view is captured using the camera. At a third step 306, the at least one image or video frame is transmitted to at least one processor of the system, and at a fourth step 308, the at least one image or video frame is analyzed by the at least one processor to determine a region of interest. The processor may utilize a suitable method, including human pose estimation using keypoint or key area detection and/or object tracking, to determine the region of interest.

In an embodiment, the processor applies a plurality of keypoints or key areas to features of a detected presenter, such as at joints, extremities, and/or facial features. The movement and relation of the keypoints or key areas may indicate a region of interest; for example, a region of interest may be determined on the basis of the proximity of certain keypoints or key areas to the camera. In an embodiment, as the keypoints or key areas pertaining to the facial features, such as the eyes, nose, chin, ears, and top of the head, extend closer to the camera relative to the body keypoints or key areas, the system may determine that the presenter is leaning in toward the camera such that focus should be directed to the upper body of the presenter by cropping out the body, arms, and legs.

In another embodiment, as particular keypoints or key areas move relative to each other more than others, for example as the hands and arms keypoints or key areas move significantly compared to the legs and/or face features, the system may determine that the hands are performing an important demonstration to which attention should be directed by cropping out the legs, body, and face. In another embodiment, the system may detect an object proximate a keypoint or key area such as a hand-related keypoint or key area, and may determine that the presenter is displaying an important material such as a book or document. The system may define the region of interest to include the object and the hands to the exclusion of the head and legs. While the above scenarios have been described, it will be appreciated that the system and method may extend to any suitable scenario.

At a fifth step 310, the image is automatically or dynamically cropped by the processor about the region of interest to remove portions of the image or video frames outside of the region of interest. The cropped image is rescaled at a sixth step 312 to a predefined resolution. For example, the predefined resolution may be 640×320 or any other suitable resolution. In embodiments, the predefined resolution is a transmission resolution that is lower than the original resolution, the lower resolution facilitating transmission of the cropped, rescaled image without causing network bottlenecks. The processor may utilize any suitable modality for rescaling the image. In some embodiments, prior to the step 310 of cropping the image or video frame, the processor may perform a distortion correction process that corrects distortions in the image or video frame. In addition to, or alternatively the processor may perform a perspective transform process to ensure that the cropped image or video frame matches the perspective that is useful for the viewer, for example ensuring that a book has the same perspective of the teacher who is using the book to teach from. In some embodiments, a bounding shape such as a bounding polygon, a bounding circle, a bounding oval, or other suitable bounding shape that more closely matches the shape of the image or video transmission to be cropped may be used instead of a bounding box as discussed previously. Accordingly, in this description any discussion of a bounding box may also apply to any suitable bounding shape.

At a seventh step 314, the rescaled image is transmitted by a communication module to one or more receivers. In embodiments, the step 314 includes transmitting the rescaled image to a plurality of receivers, such as participants in a school lecture. The communication module may utilize any suitable transmission modality, such as wired or wireless communication.

A method 350 for receiving and upscaling the transmitted images is shown and described regarding FIG. 3B. The method 350 may include a step 352 of receiving an image in a predefined resolution. The image may be received through a communication module configured to cooperate with the communication module of the presenter and configured to communicate through wired or wireless communication. The predefined resolution is the resolution transmitted by the presenter, which may be 640×320 or any other suitable resolution. In embodiments, the resolution may be sufficiently low so as to mitigate network bottlenecks.

The method 350 may include a step 354 of transmitting the received image to a processor, whereat the image is upscaled at a step 356 to a receiver display resolution. The second resolution may be higher than the resolution of the received image, and may be obtained by a suitable upscaling operation performed by the processor. The processor may utilize a suitable upscaling modality, such as an artificial intelligence module.

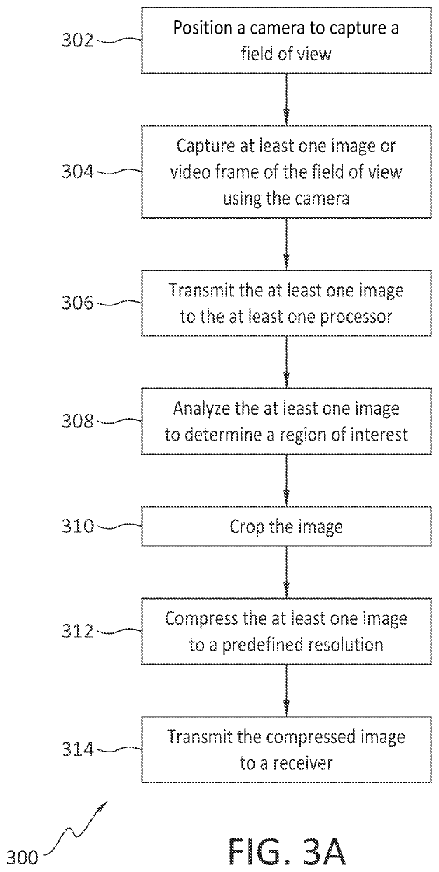

A system for dynamically cropping a video transmission according to embodiments is shown and described regarding FIGS. 4A and 4B. The system 400 of FIG. 4A may include one or more computer readable hardware storage media having stored thereon computer readable instructions that, when executed by the at one processor, cause the system to perform the method as described herein. The system 400 may include a hardware accelerator 401 such as a TPU accelerator. The hardware accelerator 401 may include one or more processors 408, a power source 412, a communication module 414, one or more artificial intelligence modules 425, and/or a storage device 410 with instructions stored 420 thereon and configured such that when operating a system with the hardware accelerator 401, the system is configured to carry out one or more steps of the methods described herein. The hardware accelerator 401 may take the form of a dongle or other device that is configured to cooperate with an existing device, such as a laptop computer, desktop computer, smartphone, or tablet. The hardware accelerator 401 may connect to the existing device in any suitable way, such as by USB connection, Wi-Fi connection, PCI-Express, Thunderbolt, M.2, or other reasonable communication protocols.

The one or more processors 408 of the hardware accelerator 401 may be configured to shift a portion, such as 1%, 25%, 50%, 75%, 90%, 100%, or otherwise, of the processing requirements of the system to the hardware accelerator 401. Providing the system 400 including the hardware accelerator 401 which is configured to cooperate with an existing device allows the system 400 flexibility in which processing resources are used, this advantageously reducing latency by minimizing the occurrence of overloaded processors.

An advantage of the system 400 is that ability to perform a bulk of or all computation on a presenter's end before transmitting to one or more viewers. This advantageously reduces bandwidth requirements and latency on the receiving end, such that the images are captured, cropped, rescaled, transmitted, received, and displayed to a viewer in substantially real-time. Embodiments utilizing direct transmission further provide an advantage of transmitting the data directly to a viewer rather than uploading the captured image data to the cloud and then from the cloud to the one or more viewers, as direct transmission further reduces bandwidth requirements. However, it will be understood that in embodiments captured image data may be transmitted to the cloud for processing before cropping and sending to one or more viewers.

The components of the hardware accelerator 401 may be configured to cooperate with a camera 402, a power source 404, a processor 405, a display 407, and a communication module 406, for example of an existing device such as a laptop computer or smartphone. The processor 405 may cooperate with the processors 408 to perform the steps of the methods described herein. While the system 400 has been shown, it will be appreciated that components associated with the hardware accelerator 401 or with an existing device may instead be provided separately from the hardware accelerator or existing device and vice versa. For example, the storage device 410 may be provided separately from the hardware accelerator 401 and/or an existing device.

In embodiments, the hardware accelerator 401 comprises an image capture device configured particularly for capturing an image or frames of a video transmission. The image capture device of the hardware accelerator 401 may be any suitable camera having a suitable resolution as discussed herein such as 1080p. The camera of the hardware accelerator 401 may be manually manipulatable by a presenter so as to orient the field of view of the camera in a desired orientation without interfering with the ability to attach the hardware accelerator 401 to an existing device.

Turning to FIG. 4B, a system 450 is an integrated device that is configured to perform the functions described herein without reliance upon a separate, existing device, such as a hardware accelerator. For example, the system 450 may be a device comprising an image capture device i.e. a camera 452, a communication module 456, one or more processors 455, an artificial intelligence module 475, a storage device 460 with instructions 470 for operating the system and method, a power source 454, a display 457, and so on such that a presenter may simply set up the system 450 in a desired location, such as in a lecture hall, music studio, medical office, or otherwise, without plugging the system 450 in to another device.

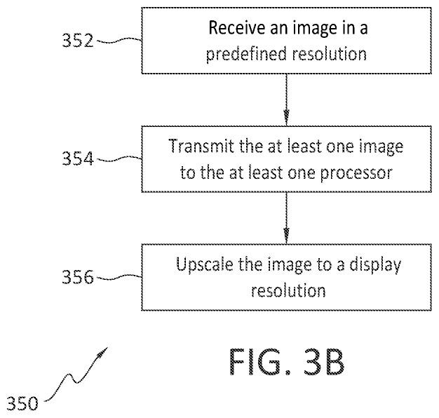

Turning now to FIGS. 5-10, modes of operation of the system and method according to embodiments are shown and described. FIG. 5 shows an annotated image 500 prepared by the system and method embodiments. The annotated image 500 represents a FULL mode of operation in which no cropping is performed. The FULL mode may be automatically determined by the system or specified by the presenter. The annotated image 500 includes an image 502 of a desired field of view including a presenter 504. The annotated image 500 may comprise at least one indicium 503 overlaid onto the image 502 and indicating a mode of operation of the system. The system for generating the image 500 uses keypoints, but it will be appreciated that key areas may alternatively or additionally be used.

The system may be configured to receive the image 502 and to perform keypoint tracking by overlaying at least one keypoint onto a presenter 504. The annotated image 500 includes left and right foot tip keypoints 506, left and right ankle keypoints 507, left and right knee keypoints 508, left and right hip keypoints 509, left and right shoulder keypoints 510, left and right elbow keypoints 511, left and right wrist keypoints 512, left and right hand tip keypoints 513, a head top keypoint 514, a nose keypoint 515, left and right eye keypoints 516, left and right ear keypoints 517, and a chin keypoint 518.

The keypoints may be connected to a proximate keypoint by a vertical skeletal connection 520. For example, the left ankle keypoint 507 may be connected by a vertical skeletal connection 520 to the left knee keypoint 508, the left knee keypoint 508 may be connected by a vertical skeletal connection 520 to the left hip keypoint 509, which may be connected by a vertical skeletal connection to the left shoulder keypoint 510, and so on. Additionally, lateral skeletal connection 522 between the left and right hip keypoints 509, lateral skeletal connection 526 between the left and right shoulder keypoints 510, and lateral skeletal connection 516 between the left and right eye keypoints may be provided. Such connecting lines may be, in embodiments, merely artificial and external to the detection of keypoints and key areas, and provision of such connections may advantageously help visualize the detection, for example as a presenter or viewer determines a custom, user-specific mode of operation or as a presenter or viewer reviews the performance of the system by examining the annotation of a single frame or series of frames of a video transmission. This may also assist a presenter or viewer in assessing whether the system is properly capturing a desired region of interest.

In embodiments, the keypoints or key areas and any associated connections may not be shown in a displayed image, either to a presenter or to a viewer. In embodiments, the keypoints or key areas and connections may be visible to the user in a keypoint or key area viewing mode, which the presenter or viewer may access through a user interface of the system. For example, the presenter or viewer may use the keypoint or key area viewing mode to ensure that a custom mode of operation has been properly specified and/or to ensure that a specific or general class of objects has been correctly learned by the system.

For example, the system may generate a “review mode” after an object or label has been presented to the system for learning, in which review mode a user may review one or more annotated frames comprising a captured image and one or more keypoints or key areas and/or associated connections. The user may correct the captured image and the one or more keypoints or key areas to facilitate the learning process by the system. For instance, the user may, using the user interface, manually reassign a keypoint or key area on the annotated image to a correct region of the object or label.

The system may dynamically track the keypoints 506, 507, 508, 509, 510, 511, 512, 513, 514, 515, 516, 517, 518 across subsequent frames 502 of a video transmission to assess a changing region of interest during a presentation.

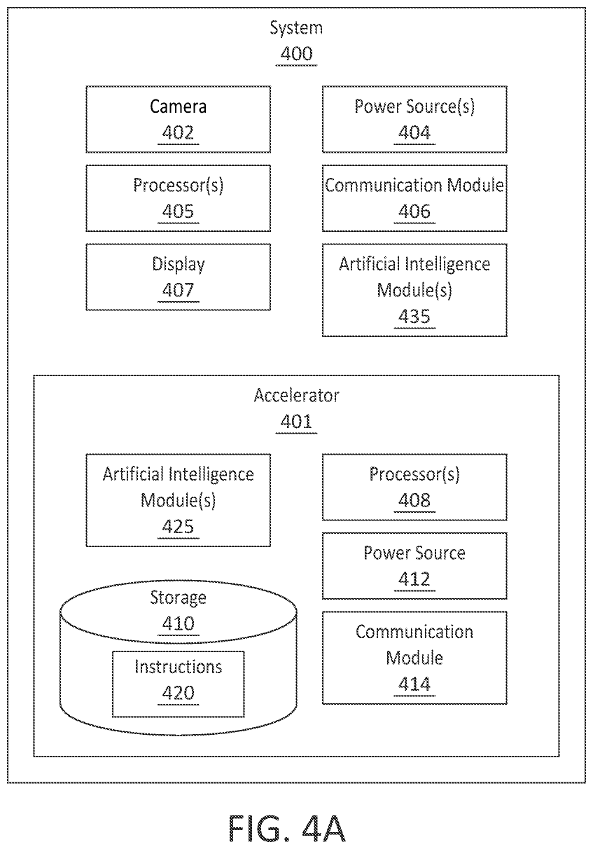

Turning to FIG. 6, an annotated image 600 representing a BODY mode of operation of a system and method for dynamically cropping a video transmission according to an embodiment is shown. The annotated image 600 may be automatically determined by the system or specified by the presenter. The annotated image 600 includes an image 602 of a desired field of view including the presenter 604. The annotated image 600 may comprise an indicium 603 overlaid onto the image 602 and indicating the BODY mode of operation of the system. As with FIG. 5, the annotated image 600 may include keypoints 606, 607, 608, 609, 610, 611, 612, 613, 614, 615, 616, 617, 618 corresponding to the foot tip, ankle, knee, hip, shoulder, elbow, wrist, hand tip, head top, nose, eye, ear, and chin, respectively. The annotated image 600 may further comprise vertical and lateral skeletal connections 620, 622, 626 as with the skeletal connections 520, 522, 526 of FIG. 5.

The annotated image 600 may comprise a region of interest 601. The region of interest 601 may be determined automatically by the processor based on the activity of the presenter 604, for example based on the movement of the keypoints frame by frame. In the embodiment of FIG. 6, the region of interest 601 may be automatically determined by the processor, based on the relative importance of each of the keypoints 606, 607, 608, 609, 610, 611, 612, 613, 614, 615, 616, 617, 618, to correspond to a BODY mode such that all of the keypoints are included in the region of interest 601. Alternatively, the presenter 604 may specify a BODY mode of operation, such that the region of interest 601 includes all of the keypoints.

An advantage of the system and method embodiments of the disclosure is that whereas existing face-detection modalities may lose track of a person when the person turns their face, the system and method advantageously provides a robust system that is able to track a presenter despite the presenter turning because of keypoint and/or key area tracking and related human pose estimation.

The processor may be configured to apply or define a bounding box 605 about the region of interest 601. The annotated image 600 may be cropped by the system such that the image 602 outside of the bounding box 605 is cropped prior to transmitting the annotated image 600. It will be understood that while the keypoints and bounding box are shown in the annotated image 600, the keypoints and bounding box may be not shown on a display of the presenter's system or in the final transmitted image received and viewed by the viewer.

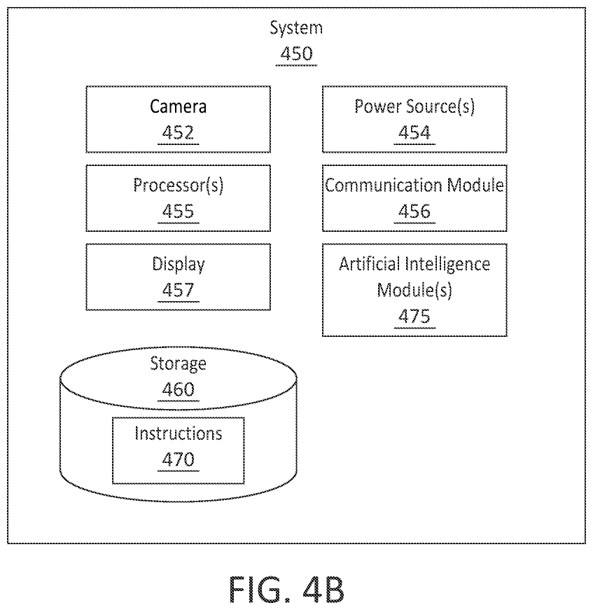

FIG. 7 shows another mode of operation. An annotated image 700 representing a HAND mode of operation is shown. The annotated image 700 comprises an image 702 of a presenter 704, which may be a frame of a video transmission, and which is automatically analyzed using the artificial intelligence modalities described herein, to determine a region of interest 701. In the HAND mode of operation, the region of interest 701 may principally concern hand-related keypoints or keypoints proximate the hand. In the annotated image 700, keypoints and skeletal connections similar to the keypoints and skeletal connections described above regarding FIGS. 5 and 6 may be applied over the image 702, including keypoints 706, 707, 708, 709, 710, 711, 712, 713, 714, 715, 716, 717, 718 corresponding to the foot tip, ankle, knee, hip, shoulder, elbow, wrist, hand tip, head top, nose, eye, ear, and chin, respectively and/or vertical and lateral skeletal connections 720, 722, 726.

However, in the HAND mode of operation, indicated to a presenter or viewer at indicium 703, only keypoints 711, 712, and 713 may be included in the region of interest 701. The system may define or apply a bounding box 705 about the region of interest 701 so as to include at least the keypoints 711, 712, 713. In embodiments, upon determination of a particular mode of operation, such as a HAND mode, the processor may automatically apply additional keypoints proximate the hands, such as at individual fingers, to better track the activity of the hands. The system may be configured to dynamically track the keypoints and crop the video transmission frame by frame so as to maintain focus on the hands regardless of movement by the presenter 704 within the field of view of the image 702. This embodiment may be advantageous in embodiments where a user is demonstrating a technique with their hands, such as in musical instrument lessons, in training demonstrations for field such as medicine, dentistry, auto repair, or other fields, or where a user may be pointing to objects such as a whiteboard.

The HAND mode of operation may be automatically determined based on the activity of the keypoints and/or the proximity of the keypoints to the camera or may be selected by a presenter or viewer. For example, a viewer participating remotely in a piano lesson may wish to manually select a HAND mode of operation so as to focus the annotated image 700 on the teacher's hands as the teacher demonstrates a complicated technique. In embodiments, a presenter may wish to manually select a HAND mode of operation in advance of a demonstration so that the entirety of an activity of interest is captured and focused on.

In other embodiments, the system may be configured to automatically adjust between a HAND mode and a HEAD mode or an UPPER mode, for example, upon a presenter or viewer indicating through an interface that the activity of interest is piano performing/teaching. In other embodiments, the system may be configured or disposed to select between a HEAD or an UPPER mode and, for example, a WHITEBOARD mode, if the presenter or viewer indicates through the interface that the activity of interest is teaching or lecturing.

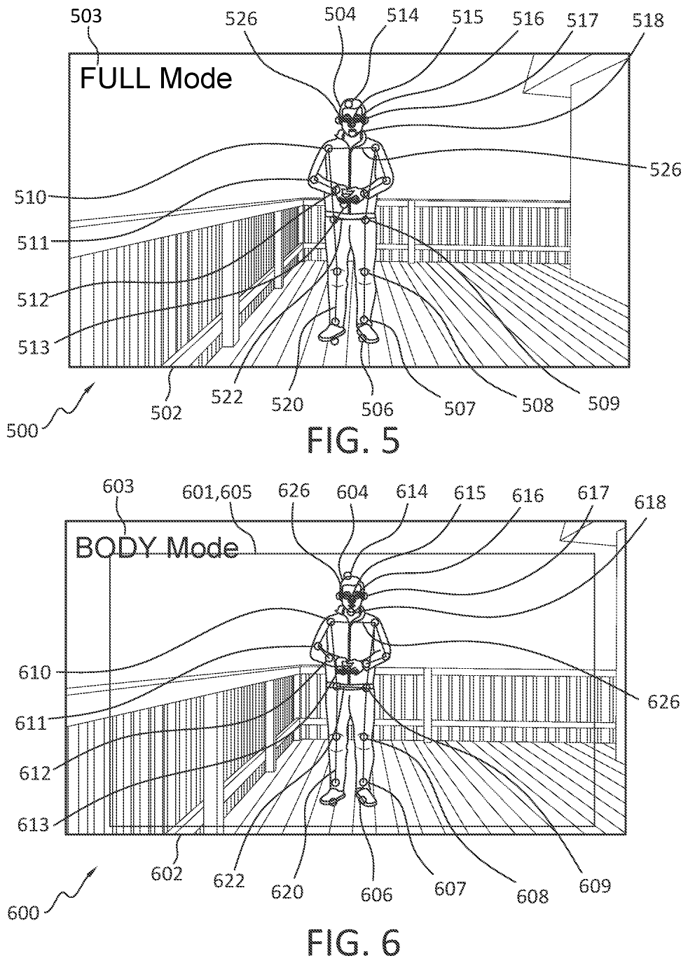

Turning now to FIG. 8, a HEAD mode of operation of a system and method for dynamically cropping a video transmission is shown and described. The annotated image 800 comprises an image 802 of a presenter 804, which may be a frame of a video transmission, and which is automatically analyzed using the artificial intelligence modalities described herein, to determine a region of interest 801. In the HEAD mode of operation, the region of interest 801 may principally concern head-related keypoints or keypoints proximate the head. In the annotated image 800, keypoints and skeletal connections similar to the keypoints and skeletal connections described above regarding FIGS. 5-7 may be applied over the image 802, including keypoints 806, 807, 808, 809, 810, 811, 812, 813, 814, 815, 816, 817, 818 corresponding to the foot tip, ankle, knee, hip, shoulder, elbow, wrist, hand tip, head top, nose, eye, ear, and chin, respectively and/or vertical and lateral skeletal connections 820, 822, 826.

In the HEAD mode of operation, indicated to a presenter or viewer at indicium 803, only keypoints 814, 815, 816, 817, and 818 may be included in the region of interest 801. The system may define or apply a bounding box 805 about the region of interest 801 so as to include at least the keypoints 814, 815, 816, 817, and 818. In embodiments, upon determination of a particular mode of operation, such as a HEAD mode, the processor may automatically apply additional keypoints proximate the head, such as at the mouth, eyebrows, cheeks, or otherwise, to better track the activity of the head and face.

The system may be configured to dynamically track the keypoints and crop the video transmission frame by frame so as to maintain focus on the head regardless of movement by the presenter 804 within the field of view of the image 802. This embodiment may be advantageous in situations where, for example, the presenter wishes to address the viewer in a face-to-face manner with the viewer able to see the presenter's face in sufficient detail to capture the presenter's message. As with other modes, the HEAD mode of operation may be automatically determined based on the activity of the keypoints and/or the proximity of the pertinent keypoints to the camera or may be selected by a presenter or viewer.

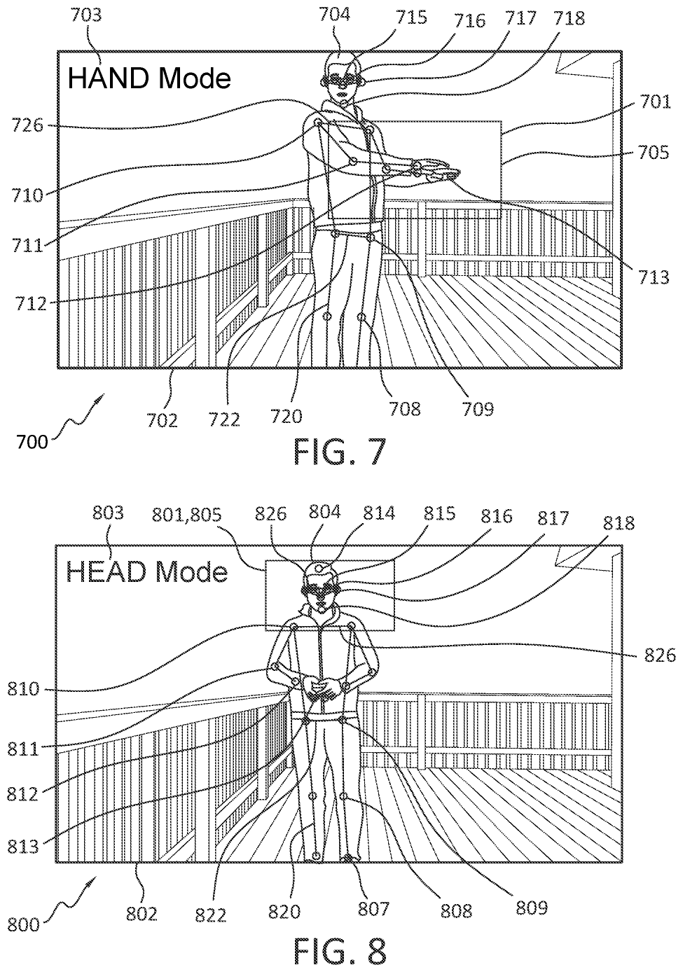

Turning now to FIG. 9, a LEG mode of operation of a system and method for dynamically cropping a video transmission is shown and described. The annotated image 900 comprises an image 902 of a presenter 904, which may be a frame of a video transmission, and which is automatically analyzed using the artificial intelligence modalities described herein, to determine a region of interest 901. In the LEG mode of operation, the region of interest 901 may principally concern leg- and foot-related keypoints or keypoints proximate the legs and feet. In the annotated image 900, keypoints and skeletal connections similar to the keypoints and skeletal connections described above regarding FIGS. 5-8 may be applied over the image 902, including keypoints 906, 907, 908, 909, 910, 911, 912, 913, 914, 915, 916, 917, 918 corresponding to the foot tip, ankle, knee, hip, shoulder, elbow, wrist, hand tip, head top, nose, eye, ear, and chin, respectively and/or vertical and lateral skeletal connections 920, 922, 926.

In the LEG mode of operation, indicated to a presenter or viewer at indicium 903, only keypoints 906, 907, 908, 909 may be included in the region of interest 901. The system may define or apply a bounding box 905 about the region of interest 901 so as to include at least the keypoints 906, 907, 908, and 909. In embodiments, upon determination of a particular of operation, such as a LEG mode, the processor may automatically apply additional keypoints proximate the leg, such as at the toes, heel, or otherwise, to better track the activity of the legs and feet.

The system may be configured to dynamically track the keypoints and crop the video transmission frame by frame so as to maintain focus on the legs regardless of movement by the presenter 904 within the field of view of the image 902. This may be advantageous in medical situations where a medical professional such as a physician, nurse, or physical therapist may instruct a patient, the presenter, to perform certain exercises or to walk to assess the patient's condition. The LEG mode advantageously allows the system to focus on the user's legs for real-time analysis of the captured image 902 without the need for expensive cameras or processors on the patient's end. As with other modes of operation, the LEG mode of operation may be automatically determined based on the activity of the keypoints and/or the proximity of the keypoints to the camera or may be selected by a presenter or viewer before or during a presentation or while viewing playback of a past presentation.

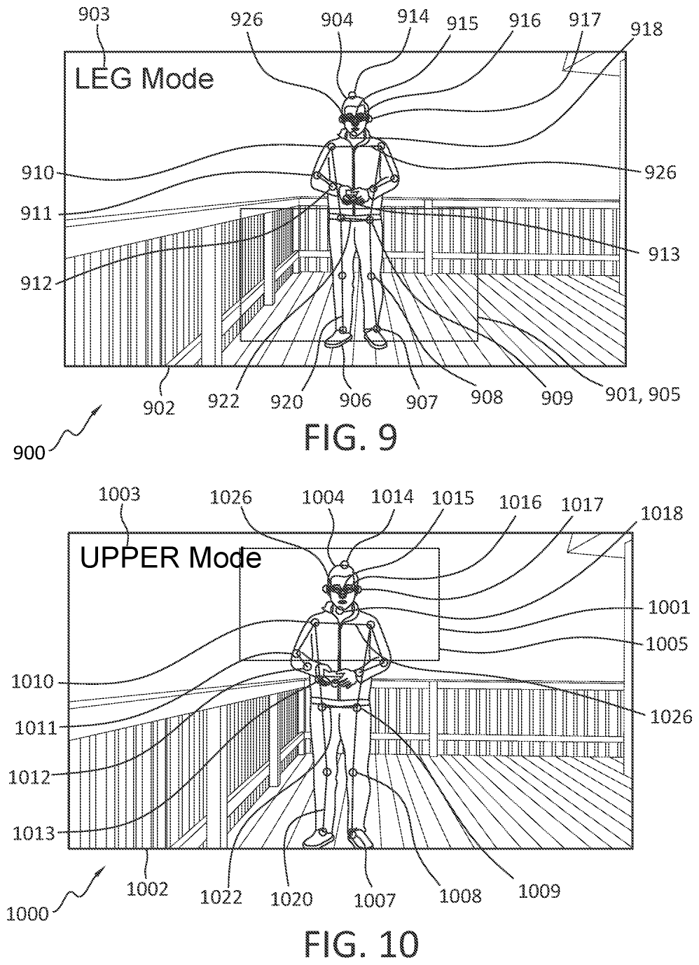

Turning now to FIG. 10, an UPPER mode of operation of a system and method for dynamically cropping a video transmission is shown and described. The annotated image 1000 comprises an image 1002 of a presenter 1004, which may be a frame of a video transmission, and which is automatically analyzed using the artificial intelligence modalities described herein, to determine a region of interest 1001. In the LEG mode of operation, the region of interest 1001 may principally concern leg- and foot-related keypoints or keypoints proximate the legs and feet. In the annotated image 1000, keypoints and skeletal connections similar to the keypoints and skeletal connections described above regarding FIGS. 5-9 may be applied over the image 1002, including keypoints 1006, 1007, 1008, 1009, 1010, 1011, 1012, 1013, 1014, 1015, 1016, 1017, 1018 corresponding to the foot tip, ankle, knee, hip, shoulder, elbow, wrist, hand tip, head top, nose, eye, ear, and chin, respectively, and/or vertical and lateral skeletal connections 1020, 1022, 1026.

In the UPPER mode of operation, indicated to a presenter or viewer at indicium 1003, only keypoints 1010, 1011, 1014, 1015, 1016, 1017, 1018 may be included in the region of interest 1001. The system may define or apply a bounding box 1005 about the region of interest 1001 so as to include at least the keypoints 1010, 1011, 1014, 1015, 1016, 1017, 1018 corresponding to the head and upper body. In embodiments, upon determination of a particular mode of operation, such as the UPPER mode, the processor may automatically apply additional keypoints proximate the head or upper body, such as at the mouth, eyebrows, cheeks, neck, or otherwise, to better track the activity of the head and upper body. This mode may be advantageous for presenters who may be speaking and referring to a demonstration, a hand-held object such as a book or image, or otherwise may involve their upper body.

It will be appreciated that while the above modes of operation and corresponding keypoints or key areas used in the automatic detection of a region of interest have been shown and described, it will be appreciated that the present disclosure is not limited to the above examples but rather may take any suitable form or variation. In embodiments, a mode of operation may utilize a predefined set of keypoints or key areas that is different from the predefined set of keypoints or key areas used for a different mode of operation. For example, a user may manually toggle to a predetermined or user-specific mode of operation pertaining to the hands, upon which the system may automatically detect an increased number of keypoints or key areas pertaining to the hands than in a standard full-body mode or upper-body mode of operation. The system may switch away from detection of the increased number of keypoints or key areas of the hands upon automatically or manually switching to a different mode of operation.

For example, the system may utilize for a HAND mode of operation a pretrained model for hand-related keypoint or key area detection involving an increased number of keypoints or key areas pertaining to the hand, such as but not limited to 1) a wrist keypoint or key area, 2) a scaphoid keypoint or key area, 3) a trapezium keypoint or key area, 4) a first metacarpal keypoint or key area, 5) a first proximal phalange keypoint or key area, 6) a thumb tip keypoint or key area, 7) a second metacarpal keypoint or key area, 8) a second proximal phalange keypoint or key area, 9) a second middle phalange keypoint or key area, 10) an index finger tip keypoint or key area, 11) a third metacarpal keypoint or key area, 12) a third proximal phalange keypoint or key area, 13) a third middle phalange keypoint or key area, 14) a middle finger tip keypoint or key area, 15) a fourth metacarpal keypoint or key area, 16) a fourth proximal phalange keypoint or key area, 17) a fourth middle phalange keypoint or key area, 18) a ring finger tip keypoint or key area, 19) a fifth metacarpal keypoint or key area, 20) a fifth proximal phalange keypoint or key area, 21) a fifth middle phalange keypoint or key area, and 22) a pinkie finger tip keypoint or key area. While the above keypoint or key areas pertaining to one or both of a presenter's hands have been described, it will be appreciated that the above embodiment is exemplary, and any suitable number, combination, and use of hand-related keypoints or key areas may be used for a HAND mode of operation, and that any suitable number, combination, and use of keypoints and key areas pertaining to a presenter or object of interest may be used specifically for one or more modes of operation of the system and method.

The system and method advantageously allow a presenter or viewer to specify a mode of operation in addition to automatic determination of a mode of operation. For example, a presenter can utilize a voice control module of the system to specify “HAND mode,” “UPPER mode,” etc. based on the presenter's determination of a region of interest for viewers. In an embodiment, the system is configured to cooperate with any suitable device, such as a mouse, keyboard, touch screen, smartphone, remote, or other device for allowing a presenter or viewer to toggle between modes. For example, a presenter may scroll their mouse to switch between modes, select a key on a keyboard corresponding to a mode, perform a gesture recognized by the system as a command to switch modes, or any other suitable means.

Embodiments of the present disclosure may comprise or utilize a special-purpose or general-purpose computer system that includes computer hardware, such as, for example, one or more processors and system memory, as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” may be defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions may comprise, for example, instructions and data which, when executed by one or more processors, cause a general-purpose computer system, special-purpose computer system, or special-purpose processing device to perform a certain function or group of functions. Computer-executable instructions may be, for example, binaries, intermediate format instructions such as assembly language, or even source code.

The disclosure of the present application may be practiced in network computing environments with many types of computer system configurations, including, but not limited to, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

The disclosure of the present application may also be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

By providing system and method for dynamically cropping a video transmission according to the present disclosure, the problems and drawbacks of existing attempts to provide automatic tracking and/or cropping are addressed. The embodiments of a system and method for dynamically cropping a video transmission advantageously provide a simple, cost-effective, and efficient system for capturing an image, determining a region of interest, cropping the video to the region of interest, and transmitting a rescaled version of the cropped video to a viewer. This advantageously reduces the cost of implementing such a system while improving online collaboration and teaching and mitigating network bottlenecks that plague existing video conferencing services.

Not necessarily all such objects or advantages may be achieved under any embodiment of the disclosure. Those skilled in the art will recognize that the disclosure may be embodied or carried out to achieve or optimize one advantage or group of advantages as taught without achieving other objects or advantages as taught or suggested.

The skilled artisan will recognize the interchangeability of various components from different embodiments described. Besides the variations described, other known equivalents for each feature can be mixed and matched by one of ordinary skill in this art to remote security solution under principles of the present disclosure. Therefore, the embodiments described may be adapted to security solutions for any context, including on-site and office settings, hotels/motels, domestic or international travel, mobile homes, and etc.

Although the system and method for dynamically cropping a video transmission has been disclosed in certain preferred embodiments and examples, it therefore will be understood by those skilled in the art that the present disclosure extends beyond the disclosed embodiments to other alternative embodiments and/or uses of the system and method for dynamically cropping a video transmission and obvious modifications and equivalents. It is intended that the scope of the present system and method for dynamically cropping a video transmission disclosed should not be limited by the disclosed embodiments described above, but should be determined only by a fair reading of the claims that follow.

1. A system for dynamically cropping a video transmission, the system comprising:
an image capture device;
a communication module;
at least one processor;
one or more computer readable hardware storage media having stored thereon computer readable instructions that, when executed by the at one processor, cause the system to instantiate an artificial intelligence module that is configured to perform the following:
receive an image from the image capture device;
determine a region of interest in the image; and
dynamically crop the image to the region of interest.

2. The system of claim 1, wherein the at least one processor is further configured to rescale the image to a transmission resolution lower than an original resolution.

3. The system of claim 1, further comprising a second processor configured to upscale the cropped image to a display resolution of a display.

4. The system of claim 3, wherein the display resolution is higher than the transmission resolution, is the same as the original resolution, or is a resolution that is lower than the original resolution that conforms with the display resolution of the display.

5. The system of claim 1, wherein the at least one processor determines the region of interest using a human pose estimation model.

6. The system of claim 5, wherein the human pose estimation model utilizes one or more predefined human keypoints or key areas.

7. The system of claim 6, wherein the one or more predefined human keypoints or key areas comprise at least one joint and at least one body extremity.

8. The system of claim 6, wherein the one or more predefined human keypoints or key areas comprise at least a foot tip keypoint or key area, an ankle keypoint or key area, a knee keypoint or key area, a hip keypoint or key area, a shoulder keypoint or key area, an elbow keypoint or key area, a wrist keypoint or key area, and a hand tip keypoint or key area.

9. The system of claim 6, wherein the one or more predefined human keypoints or key areas further comprise at least a head top keypoint or key area, a nose keypoint or key area, an eye keypoint or key area, an ear keypoint or key area, and a chin keypoint or key area.

10. The system of claim 1, wherein the at least one processor is configured to automatically define a bounding shape about the region of interest, wherein the region of interest includes keypoints or key areas of interest, wherein the image is cropped about the bounding shape.

11. The system of claim 1, wherein the region of interest is determined by keypoints or key areas of interest and the keypoints or key areas of interest are determined according to one or more modes of operation, the one or more modes of operation comprising a full mode, a body mode, a head mode, an upper mode, a hand mode, and a leg mode.

12. The system of claim 11, wherein the system is configured to automatically select a mode of the one or more modes of operation.

13. The system of claim 11, wherein the system is configured to receive a presenter selection of a mode of the one or more modes of operation or to receive a viewer selection of a mode of the one or more modes of operation.

14. The system of claim 1, wherein the region of interest is determined based on a proximity of one or more predefined human keypoints or key areas or based on an activity of the one or more predefined human keypoints or key areas.

15. A method for an artificial intelligence module to dynamically crop a video transmission, the method comprising:
positioning an image capture device to capture a field of view;
capturing at least one image using the image capture device;
transmitting the at least one image to at least one processor;
analyzing the at least one image to determine a region of interest; and
dynamically cropping the at least one image according to the determined region of interest.

16. The method of claim 15, further comprising:
rescaling the at least one image to a predefined resolution; and
transmitting the at least one image to a receiver.

17. The method of claim 15, wherein the step of analyzing the at least one image to determine a region of interest comprises:
assigning at least one predefined human keypoint or key area onto the at least one image, the at least one predefined human keypoint or key area corresponding to a feature of a presenter;
determining a proximity of the at least one predefined human keypoint or key area to the image capture device; and
determining the region of interest based on the proximity.

18. The method of claim 15, wherein the step of analyzing the at least one image to determine a region of interest comprises:
assigning at least one predefined human keypoint or key area onto the at least one image, the at least one predefined human keypoint or key area corresponding to a feature of a presenter;
determining an activity of the at least one predefined human keypoint to the image capture device; and
determining the region of interest based on the activity.

19. The method of claim 15, further comprising the step of utilizing a stabilization algorithm configured to smooth the at least one image after determining the region of interest.

20. A computer program product comprising one or more computer-readable hardware storage media having thereon computer-executable instructions that are structured such that, when executed by one or more processors of a computing system, cause the computing system to instantiate an artificial intelligence module that is configured to perform method for dynamically cropping video transmission, the method comprising:
positioning an image capture device to capture a field of view;
capturing at least one image using the image capture device;
transmitting the at least one image to at least one processor;
analyzing the at least one image to determine a region of interest; and
dynamically cropping the at least one image according to the determined region of interest
